(19) United States
(12) Patent Application Publication
(10) Pub. No.: US 2021/0154937 A1
(43) Pub. Date: May 27, 2021

(54) THREE-DIMENSIONAL (3D) PRINTING USING BOUNDING

(71) Applicant: Hewlett-Packard Development Company, L.P., Spring, TX (US)

(72) Inventors: Craig Peter Sayers, Palo Alto, CA (US); William E Hertling, Vancouver, WA (US); Helen Balinsky, Bristol (GB)

(73) Assignee: Hewlett-Packard Development Company, L.P., Spring, TX (US)

(21) Appl. No.: 17/047,365

(22) PCT Filed: Aug. 9, 2018
(86) PCT No.: PCT/US2018/046113

§ 371 Date: Oct. 13, 2020

(51) Int. Cl. B29C 64/386; B29C 64/171; B33Y 50/00; B33Y 10/00; B33Y 30/00; G05B 19/4099; G06Q 30/02; G06Q 50/18; G06Q 10/10; G06Q 10/06; G06Q 30/00; G06Q 20/40

(52) U.S. Cl. CPC B29C 64/386; B29C 64/171; B33Y 50/00; B33Y 10/00; B33Y 30/00; G05B 19/4099; B29C 64/153; G06Q 50/18; G06Q 10/10; G06Q 10/06313; G06Q 30/0185; G06Q 20/407; G06Q 30/0206

(57) ABSTRACT

A three-dimensional (3D) printing device includes a processor and memory communicatively coupled to the processor. The processor verifies that a digital contract certified by an authorized party is authentic and applicable. The digital contract includes a process bound, a part bound for each part in a packed bed of parts, a time bound, and a cost identifier to define a cost of printing the packed bed that is based on the process bound, the part bound for each part in the packed bed of parts, and the time bound.

### BACKGROUND

Some additive manufacturing systems produce three-dimensional (3D) objects by building up layers of material and combining those layers using adhesives, heat, chemical reactions, and other coupling processes. Some additive manufacturing systems may be referred to as “3D printers.” The additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a three-dimensional (3D) printing device, according to an example of the principles described herein.

FIG. 2 is a block diagram of a 3D printing device, according to an example of the principles described herein.

FIG. 3 is a block diagram of a system for 3D printing, according to an example of the principles described herein.

FIG. 4 is a block diagram of a batch of printed parts including bounding proxies for each of the parts within the batch, according to an example of the principles described herein.

FIG. 5 is a block diagram of a quotation computing device, according to an example of the principles described herein.

FIG. 6 is a flowchart showing a method of 3D printing, according to an example of the principles described herein.

FIG. 7 is a flowchart showing a method of 3D printing, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing parts using an additive manufacturing device or 3D printing device may be expensive depending on the materials and processes used to form the parts. Therefore, it is desirable for the user to approve a print job based on an informed and/or contracted cost.

Further, processes within a 3D printing system may be made more efficient by encouraging users to print multiple parts in one batch. A batch may be defined as a number of parts that are to be printed within a print job. A print bed of an additive manufacturing device may have sufficient space such that a plurality of parts may be “packed” or oriented and arranged within the print bed and printed simultaneously to amortize the cost of printing a batch across more parts and to reduce the time taken to print the parts. The more parts that may be packed into the print bed, the lower the costs in materials, time, and wear on the additive manufacturing device.

Still further, the user may have proprietary part designs and printer process settings that the user wishes to remain private and secure. Thus, a user would likely desire a way of keeping the user's part models, resulting printed parts, and other proprietary information private while still receiving accurate price quotes.

Still further, the 3D printing device or materials may be supplied to the user by another entity. Rather than charge directly for the 3D printer usage or materials, that entity may charge a fixed price for printing a batch and may desire a way to give the user an accurate price and provide offline printing while still keeping the pricing model private. The volume of parts printed roughly correlates with the amount of powder and other materials used to print the parts. There is some overhead to printing each batch of parts, and, therefore, the most efficient packing of the print bed of the 3D printing device may be most cost effective for the user.

Examples described herein provide a three-dimensional (3D) printing device. The 3D printing device includes a processor and memory communicatively coupled to the processor. The processor verifies that a digital contract certified by an authorized party is authentic and applicable. The digital contract includes a process bound, a part bound for each part in a packed bed of parts, a time bound, and a cost identifier to define a cost of printing the packed bed that is based on the process bound, the part bound for each part in the packed bed of parts, and the time bound.

The digital contract defines a number of additional constraints including a limited time period in which the batch may be printed, a printer model, a printer instance, a number of print parameters, a number of printing processes, or combinations thereof. Verifying that the digital contract is authentic and applicable is performed by executing a verification module. The verification module verifies that a printing process is within the process bounds defined by the digital contract, verifies that a time window in which the packed bed is to be printed by the printing device is within time bounds defined by the digital contract, prints the packed bed of parts in response to a determination that the digital contract is authentic and applicable.

The 3D printing device may include an increment module to increment a counter indicating a number of times the digital contract has been used.

The 3D printing device includes a success module to determine if the printing of at least one object failed, and in response to a determination that the printing of the object failed, sending failure information defining the failed printing of the object to a quotation module. When the quotation module subsequently is asked to price similar parts or batches, the past failure information may be used to adjust a probability of success used in calculating the cost of printing the similar parts or batches.

Examples described herein provide a system for three-dimensional (3D) printing. The system includes a bounding proxy module to determine a bounding proxy for each object to be printed in a batch within the 3D printing device. The bounding proxy includes a set of constraints of at least one attribute of each of the objects in the batch. The system also includes a bounding process module to determine bounding properties for a print process of a 3D printing device. The bounding properties define constraints on at least one metric of the printing process. The system also includes a success module to determine a probability of success of printing the batch, and a quotation module to compute a cost of printing the batch based on the bounding properties and the probability of success of printing the batch.

The system includes a digital contract module to distribute a digital contract to a user. The digital contract includes at least the cost of printing the batch. The bounding proxy for each object defines a shape that individually encloses each of the objects within the batch, and wherein the digital contract maintains secrecy of the objects within the batch based on the bounding proxy.

Examples described herein provide a method of three-dimensional (3D) printing. The method includes determining a part bound for each part to be printed in a batch. The part bound includes a set of constraints of at least one attribute of each of the parts in the batch. The method also includes determining process bounds for a 3D printing device. The process bounds defining at least one constraint on at least one metric of the printing process. The method also includes, with a quotation module, computing a cost of printing the batch based on the batch and process bounds, and, with a digital contract module, distributing a digital contract to a user, the digital contract comprising the cost of printing the batch, where the contract and the batch are interlinked by, for example, a shared identification referencing each other, or other means.

The method also includes, with a success module, determining a probability of success of the batch. Computing the cost of printing the batch is based on the probability of success of the batch. The part bound for each part defines a shape that individually encloses each of the parts within the batch, and the digital contract maintains secrecy of the parts within the batch based on a bounding proxy of the part bound.

The method also includes determining if the printing of at least one part failed, and, in response to a determination that the printing of the part failed, sending failure information defining the failed printing of the part to the quotation module, and adjusting a probability of success of a similar batch.

As used in the present specification and in the appended claims, the term “3D printing device,” “additive manufacturing device” or similar language is meant to be understood broadly as any device capable of causing material to be joined or solidified under computer control to create a three-dimensional object or part. A 3D printing device may include, for example, a laser sintering device, selective laser sintering device, direct metal laser sintering device, laser melting device, selective laser melting device, direct metal laser sintering device, electron beam melting device, powder bed 3D printing device, powder bed fusion device, or any variants, derivatives, or combinations thereof which are capable of printing more than one part in a single batch.

Further, as used in the present specification and in the appended claims, the terms “part” or “object” is meant to be understood broadly as any 3D element that may be printed by a 3D printing device.

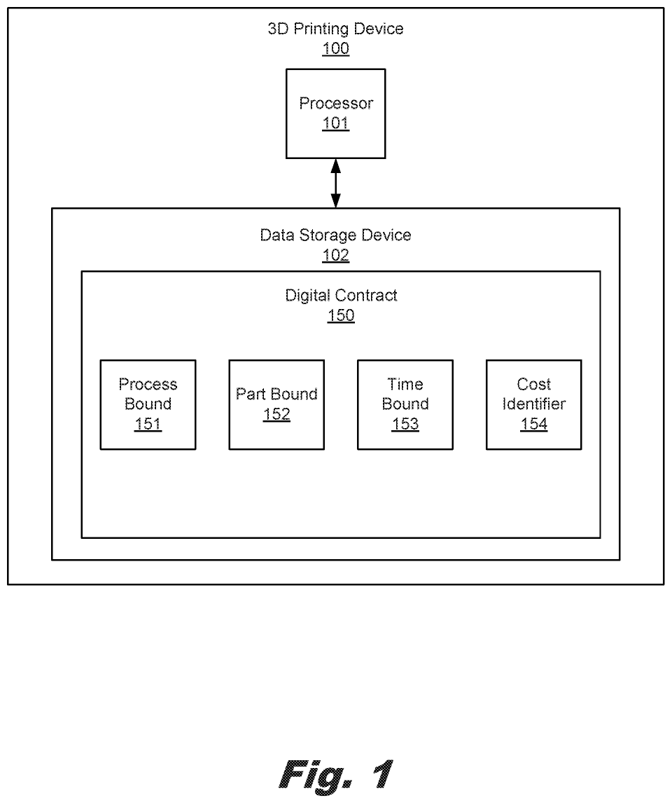

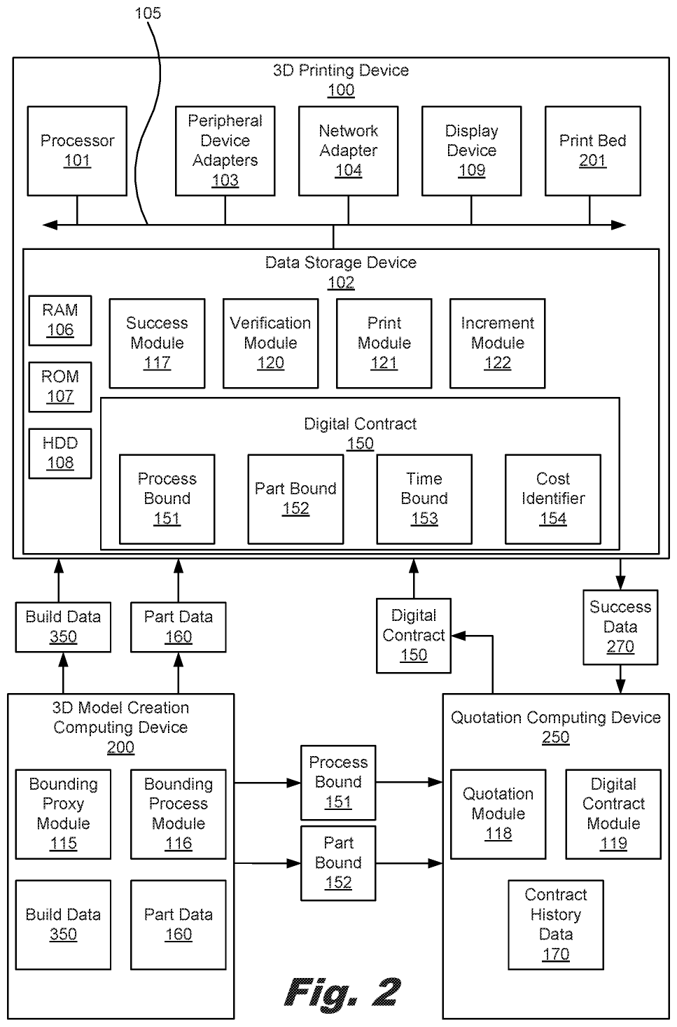

Turning now to the figures, FIG. 1 is a block diagram of a three-dimensional (3D) printing device (100), according to an example of the principles described herein. The 3D printing device (100) includes a processor (101) and a data storage device (102) communicatively coupled to the processor (100). The data storage device (102) may contain computer readable and computer executable code that the processor may execute in bringing about the functions described herein. For example, the processor, when executing the computer readable and computer executable code, may verify that a digital contract (150) certified by an authorized party is authentic and not tampered with. The digital contract (150) may also be referred to herein and in the claims as a digital key as the digital contract also functions as authorization to perform a print job on a 3D printing device (100). A user may use the 3D printing device (100) of his or her own or may contract with another party to have a number of parts printed by the 3D printing device (100), and, in order to inform the user of the costs associated with the printing of the parts, make the printing of the parts more efficient and cost effective, and secure the user's proprietary part models, printer settings, printer processes, and pricing models, a contract may be entered into. In order enact a fulfillment of the batch by the 3D printing device (100), the 3D printing device (100) may require the digital contract (150) to affirm that the print job for the parts is appropriate for the 3D printing device (100) and that the user is informed of the costs, efficiency, and security of the print job. The issuance of the digital contract (150) is made by the quotation computing device (FIG. 2, 250) executing the digital contract module (FIG. 2, 250).

The digital contract (150) may be stored in the data storage device (102) for analysis by the processor (101) in this manner. The digital contract may include a process bound (151), a part bound (152) for each part in a packed bed of parts, a time bound (153), and a cost identifier (154) to define a cost of printing the packed bed that is based on the process bound (151), the part bound (152) for each part in the packed bed of parts, and the time bound (153). In an example, the digital contract (150) may serve as or include a digital signature that authenticates the contract, certifies that it has not been altered and, may include a form of cryptographic protocol that indicates that the communications between a computing device used by the user and the 3D printing device (100) is authentic and secure.

The process bound (151) of the digital contract (150) may define the processes used to print, form, or create the parts within the print job. These processes may include the use of particular devices including a 3D printer along with the activation of lasers, the deposition of building materials, the heating and/or cooling of parts during the printing process, post printing processes such as polishing or cutting, waiting a period of time for annealing of the parts, other processes used to form the parts, or combinations thereof. The processes defined by the process bound (151) may also be used to determine if the 3D printing device (100) can perform the processes defined in the digital contract (150) to ensure that the user's print job is executed as contractually mandated. The process bounds (151) may include a range of print process settings. For example, the process bounds (151) may specify a layer thickness of each consecutive layer of materials deposited to form the parts, and may, for example, be defined as being be between 80 and 90 microns. Further, an annealing time may be defined as a process bound (151) and may, for example, be defined as between 4 and 5 hours. Other processes used in forming the parts may be defined and added as a process bound (151) in the digital contract (150).

The part bound (152) of the digital contract (150) is used to determine the efficiency in time, cost, and use of printing space and materials of the user's print job. The print job created by the user and defined by the digital contract (150) defines how the parts to be printed by the 3D printing device (100) are digitally arranged within a print bed and how they will physically be arranged within the print bed of the 3D printing device (100) when printed. As the parts are prepared by the 3D printing device (100) and other computing devices for printing, the parts may be digitally arranged or packed in the print bed and visualized by the 3D printing device and/or displayed to a user on a display device associated with the 3D printing device (100). The parts may be digitally arranged within the print bed such that as many parts as possible may be included within the print bed and the print job in an efficient and effective arrangement. For example, the parts may be close enough to one another to minimize any wasted space between the parts, but separated such that the printing of any individual part does not affect the printing of another part. A part bound may define how these parts are to be arranged.

Further, the part bound (152) may also include a bounding proxy that includes a set of constraints defining the size and other attributes of the part. For each part to be printed in a packed batch, a bounding proxy may be created. The bounding proxy includes a set of constraints that define the size, shape, orientation, arrangement, and other attributes for the part. The geometric bounding proxies are packed into a print bed in an efficient manner such that the parts are as close together as possible, but not too close to where the printing of one part overlaps the printing of a neighboring part or the printing of one part can negatively affect the printing of the neighboring part.

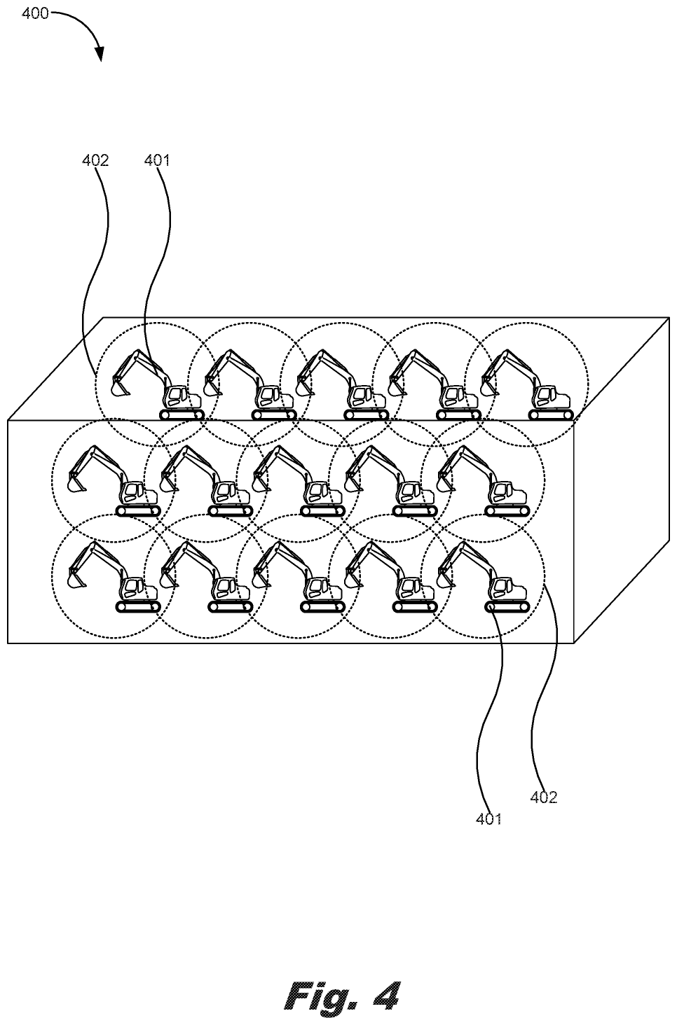

Referring to FIG. 4, FIG. 4 is a block diagram of a batch (400) of printed parts (401) including bounding proxies (402) for each of the parts (401) within the batch (400), according to an example of the principles described herein. The parts (401) depicted in FIG. 4 are model front end loaders, but it is clear that the part may have any shape and size, and the part (401) is not limited as to its shape and size.

The batch (400) as presented in FIG. 4 has as its boundary a three-dimensional space which has a volume that is limited by the size of the print bed (FIG. 2, 201) of the 3D printing device (100). The parts (401) may be digitally arranged in the 3D space of the batch (400) to match an arrangement that the parts (401) are to be printed within the print bed (FIG. 2, 201) of the 3D printing device (100). The part bounds (152) may be defined by the bounding proxies (402) which may be, for example, geometric bounding proxies for the parts (401).

The bounding proxies (402) include a shape which completely encloses the parts (401). A sphere is depicted as the shape in FIG. 4. However, the shape of the bounding proxies (402) may be any shape which encloses the parts (401). The bounding proxies (402), in one example, may be larger than the part, and, thus, may be used in calculating a cost for the digital contract (150) without disclosing the exact part shape of the part. The bounding proxies (402), in one example, may provide flexibility for the user to make later changes to the design of the parts (401). In another example, the bounding proxies (402) may closely follow the outer contours of the part (401) that will give a lower cost estimate based in the bounding proxies (402), but, at the same time, provides less security and a relatively limited ability to alter the design of the parts (401) due to the bounding proxies (402) revealing more elements and contours of the parts (401). Part bounds (152) and the associated bounding proxies (402) that define the packed print bed (FIG. 2, 201) may also define bounds on the volume, density, surface area, applied colors, other parameters, or combinations thereof of the parts (401).

As part of the part bound (152), the bounding properties for the packed bed may be computed. The bounding properties of the part bound (152) may include metrics such as density, total surface area of the parts, and may be included with data regarding the locations, orientations, arrangements, and bounding proxies for each part within the batch.

The digital contract (150) may also include a time bound (153). The time bound defines a window of time in which the digital contract (150) is valid. Once a user enters into a contract to print the parts using the 3D printing device (100), the contract terms may include temporal limitations such as a period of time thereafter when printing may occur. In an example, the time bound (153) may be measured in any time increment or combinations of time increments including minutes, hours, days, weeks, months, or years. In another example the time bound (153) may be a date before or after which the contract is no longer valid.

The digital contract (150) may also include a cost identifier (154) that indicates a cost to the user of the 3D printing device (100). The cost identifier (154) may include a fixed cost per batch printing, a cost per part within a batch, a cost per cubic measurement (e.g., cubic centimeters), bulk costs if the user should request an amount of parts to be printed above a certain threshold, cost per printing of each print job or batch of parts, costs for printing a number of batches of parts, other cost parameters, and combinations thereof. Informing the user of the costs prior to the user printing the parts increases consumer satisfaction and confidence. In one example, the manner in which the costs are calculated may be keep secret as a type of proprietary information. The authenticity of the costs provided by the cost identifier (154) may be maintained through the digital contract (150) and the security afforded through the digital signature and cryptographic protocol associated with the digital contract (150).

In one example, a plurality of cost identifiers (154) may be provided to the user. In this example, a first cost identifier (154) may be provided that is valid if fulfilled before a specified date or between a first range of dates, and a second cost identifier (154) may be provided that is valid after a specified date or during a second date range. The two costs associated with the two separate cost identifiers (154) in this example may be different. Further, in one example, a single cost identifier (154) may be provided that includes data defining a plurality of costs that are based on valid for different dates.

FIG. 2 is a block diagram of a 3D printing device (100), according to an example of the principles described herein. In addition to the description provided above in connection with the 3D printing device (100) of FIG. 1, the 3D printing device (100) may be utilized in any data processing scenario including, stand-alone hardware, mobile applications, through a computing network, or combinations thereof. Further, the 3D printing device (100) may be used in a computing network, a public cloud network, a private cloud network, a hybrid cloud network, other forms of networks, or combinations thereof.

In an example, the methods provided by the 3D printing device (100) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof.

The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the 3D printing device (100) are executed by a local administrator.

To achieve its desired functionality, the 3D printing device (100) comprises various hardware components. Among these hardware components may be a number of processors (101), a number of data storage devices (102), a number of peripheral device adapters (103), a number of network adapters (104), a number of display devices (109), and a number of print beds (201). These hardware components may be interconnected through the use of a number of busses and/or network connections. In one example, the processor (101), data storage device (102), peripheral device adapter (103), network adapter (104), display device (109), and print bed (201) may be communicatively coupled via a bus (105).

The processor (101) may include the hardware architecture to retrieve executable code from the data storage device (102) and execute the executable code. The executable code may, when executed by the processor (101), cause the processor (101) to implement at least the functionality of receiving a digital contract, verifing the authenticity of the digital contract, verifing a time bound within the digital contract is valid, if provided, verifing bounding proxies for the parts to be printed from a build data 350 are within a part bound of the digital contract, defining a number of process parameters, verifying the process parameters set are within a process bound of the digital contract, printing the parts, incrementing a counter indicating a number of times the digital contract has been used, and other functions described herein and combinations thereof, according to the methods of the present specification described herein. In the course of executing code, the processor (101) may receive input from and provide output to a number of the remaining hardware units.

The data storage device (102) may store data such as executable program code that is executed by the processor (101) or other processing device. As described herein, the data storage device (102) may specifically store computer code representing a number of applications that the processor (101) executes to implement at least the functionality described herein.

The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the processor (101) may boot from Read Only Memory (ROM) (107), maintain nonvolatile storage in the Hard Disk Drive (HDD) memory (108), and execute program code stored in Random Access Memory (RAM) (106).

The data storage device (102) may comprise a computer readable medium, a computer readable storage medium, or a non-transitory computer readable medium, among others. For example, the data storage device (102) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103, 104) including the peripheral device adapters (103) and the network adapter (104) in the 3D printing device (100) enable the processor (101) to interface with various other hardware elements, external and internal to the 3D printing device (100). For example, the peripheral device adapters (103) may provide an interface to input/output devices, such as, for example, the display device (109), a mouse, or a keyboard. The peripheral device adapters (103) may also provide access to other external devices such as a 3D model creation computing device (200), an external storage device, a number of network devices such as, for example, servers, switches, and routers, client devices, other types of computing devices, and combinations thereof.

The display device (109) may be provided to allow a user of the 3D printing device (100) to interact with and implement the functionality of the 3D printing device (100) and to convey to the user information such as the digital contract (150). Elements of the digital contract (150) may be displayed on the display device (109) in a user-readable format for the user. The peripheral device adapters (103) may also create an interface between the processor (101) and the display device (109), a printer, or other media output devices. The network adapter (104) may provide an interface to other computing devices within, for example, a network, thereby enabling the transmission of data between the 3D printing device (100) and other devices located within the network.

The 3D printing device (100) further comprises a number of modules used in the implementation of the 3D printing device (100) described herein. The various modules within the 3D printing device (100) comprise executable program code that may be executed separately. In this example, the various modules may be stored as separate computer program products. In another example, the various modules within the 3D printing device (100) may be combined within a number of computer program products; each computer program product comprising a number of the modules.

The 3D printing device (100) may include a bounding proxy module (115) to, when executed by the processor (101), define a number of constraints limiting the size and other attributes of the parts to be printed by the 3D printing device (100). For each part to be printed in a packed batch, a bounding proxy may be created. The bounding proxy includes a set of constraints that limit the size, shape, orientation, arrangement, and other attributes for the part. The 3D printing device (100) executes the bounding proxy module (115) to pack the parts into a print bed in an efficient manner such that the parts are as close together as possible, but not too close to where the printing of one part overlaps the printing of a neighboring part or the printing of one part can negatively affect the printing of the neighboring part.

The 3D printing device (100) may include a bounding process module (116) to, when executed by the processor (101), define a number of the processes used to print, form, or create the parts within the print job. These processes may include the activation of lasers, the deposition of building materials, the heating and/or cooling of parts during the printing process, post printing processes such as polishing or cutting, waiting a period of time for annealing of the parts, other processes used to form the parts, or combinations thereof. The processes defined by the process bound (151) may also be used to determine if the 3D printing device (100) can perform the processes defined in the digital contract (150) to ensure that the user's print job is executed as contractually mandated.

The 3D printing device (100) may include a success module (117) to, when executed by the processor (101), determine a probability of success of printing the parts on a per part basis or a per batch basis. The probability of success may be the probability of printing the parts without defect and in accordance with part data. The probability of success may be based on the packing density of the parts within the batch, the process bounds (151), the part bounds (152), previous success rates with identical or similar print jobs with the same or other users on the same or another 3D printing device, other parameters from the build, and combinations thereof. The probability of success may be used as part of the calculation of costs to the user and may be provided to the user as well as the costs associated with the printing. Further, the probability of success may also be used when generating subsequent digital contracts (150). In one example, the probability of success defined by the success module (117) may be computed per part, per batch, or a combination thereof. The quoted price provided by the quotation module (118) may include a breakdown of the price of each part in the batch, where if a part failed, the cost for that part could be refunded.

A quotation module (118) may also be included in the 3D printing device (100). The quotation module (118) computes costs associated with the printing of the parts and batches. In an example, the costs may be based on the process bounds (151), a part bounds (152), time bounds (153), and the probability of success defined by the success module (117). The quotation module (118) provides the calculated costs to a digital contract module (119) for the digital contract module (119) to create a signed digital contract including the details of the computed costs. The quotation module (118) may create the cost identifier (154) including include a fixed cost per batch printing, a cost per part within a batch, a cost per cubic measurement (e.g., cubic centimeters), bulk costs if the user should request an amount of parts to be printed above a certain threshold, cost per printing of each print job or batch of parts, costs for printing a number of batches of parts, other cost parameters, and combinations thereof.

The quotation computing device (250) may also include a digital contract module (119) to create a digital contract (150) for signature by the user. The digital contract module (119) may produce the digital contract (150) that includes the process bounds (151), the part bounds (152), the time bounds (153), and the cost identifiers (154) described herein. Further, a form of cryptographic protocol may be applied to the digital contract (150) by the digital contract module (119) to create and maintain a level of security for the information contained within the digital contract (150) and described herein.

The verification module (120) of the 3D printing device (100) verifies that the digital contract (150) is correctly signed by the user (i.e., purchaser of the print services whether that user is the owner of the 3D printing device (100) or not) and has not been altered or intercepted during the sending of the digital contract (150) to another computing device or to the 3D printing device (100). The verification module (120) of the 3D printing device (100) also verifies that the part data that includes part models of the parts to be printed by the 3D printing device (100) fit within the process bounds (151), part bounds (152), time bounds (153) and that all other bounding properties for the batch or batches of parts to be printed are satisfied.

In some situations, the verification provided by the verification module (120) may identify that the verification has failed due to the use of a 3D printing device (100) that cannot meet the process bounds (151), part bounds (152), time bounds (153) or the part data (160) does not meet these bounds, the 3D printing device (100) may display, on the display device (109) an error for the user and the process stops. In contrast, should the verification module (120) determine that there is no issue with the print job, the print module (121) may be executed by the processor (101) to print the parts within the batches requested by the user within the print bed (201) of the 3D printing device (100).

The 3D printing device (100) may also include an increment module (122) to increment a count as to the number of times a print job is executed by the 3D printing device (100) using the digital contract (150). The digital contract (150) may include, in its time bound (153) a limitation as to how many times a print job may be executed by the 3D printing device (100). For example, if the time bound (153) of the digital contract (150) limits the number of batches that may be printed under the digital contract (150) to 10, then the user may only use that digital contract (150) for those ten batches and must enter into another digital contract before printing more batches once the initial ten batches have been printed.

The data storage device (102) also stores part data (160). The part data (160) is any type of data that provides instructions to the 3D printing device (100) as to how to print the parts defined thereby. In an example, CAD model data defining the parts may be used to create the part data (160) for consumption by the 3D printing device (100) and the various modules thereof.

The data storage device (102) may also store contract history data (170). The contract history data (170) includes information regarding past digital contracts (150) the user and other users have previously entered into. In one example, the digital contract module (119) may use the contract history data (170) to prepare and/or offer a digital contract (150) to the user that may meet the user's desired contract. For example, a user may have previously obtained a digital contract (150) with a number of process bounds (151), part bounds (152), time bounds (153), and cost identifiers (154), and may wish to enter into the same or a similar contract. In this example, the contract history data (170) may be accessed by the digital contract module (119) to discover previous digital contracts (150) entered into by the user. This may expedite the user's experience with the methods and systems described herein that may result in a better user satisfaction.

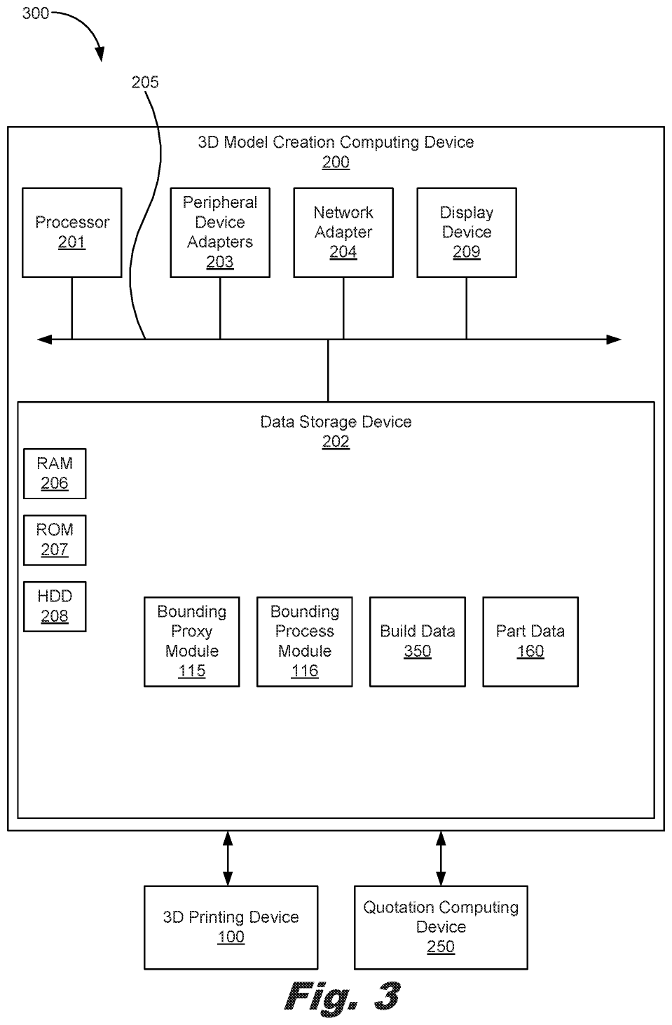

The 3D printing device (100) may be communicatively coupled to a 3D model creation computing device (200). The 3D model creation computing device (200) may be any device the user may utilize to interface with the 3D printing device (100), and is used to analyze parts for printing on the 3D printing device (100), compute bounding proxies, pack the build of the parts into the print bed (201), and select processes bounds (151) for printing the parts. FIG. 3 is a block diagram of a system (300) for 3D printing, according to an example of the principles described herein. The 3D model creation computing device (200) of FIG. 2 is described in more detail in connection with FIG. 3. The 3D model creation computing device (200) of FIG. 3 is communicatively coupled to the 3D printing device (100) of FIG. 2, and includes its own processor (201), data storage device (202), peripheral device adapter (203), network adapter (204), RAM (206), ROM (207), HDD (208), and display device (209) coupled via a bus (205) that are similar to the processor (101), data storage device (102), peripheral device adapter (103), network adapter (104), RAM (106), ROM (107), HDD (108), display device (109), and bus (105) described above in connection with the 3D printing device (100) of FIG. 2. In one example, the 3D model creation computing device (200) may also serve as a device a user may utilize to create 3D models and may include, for example, computer-aided drafting (CAD) programming to assist in this function.

Further, the data storage device (202) of the 3D model creation computing device (200) may store executable code in the form of modules such as the bounding proxy module (115), and bounding process module (116). Further, the data storage device (202) of the 3D model creation computing device (200) may store build data (350) and part data (160).

The bounding proxy module (115), when executed by the processor (101), defines a number of constraints limiting the size and other attributes of the parts to be printed by the 3D printing device (100). For each part to be printed in a packed batch, a bounding proxy may be created. The bounding proxy includes a set of constraints that limit the size, shape, orientation, arrangement, and other attributes for the part. The 3D model creation computing device (200) executes the bounding proxy module (115) to pack the parts into a print bed in an efficient manner such that the parts are as close together as possible with, but not too close to where the printing of one part overlaps the printing of a neighboring part or the printing of one part can negatively affect the printing of the neighboring part. Further, the bounding proxy module (115) assists, with the bounding process module (116) in creating the process bound (151) and part bound (152). The process bound (151) and part bound (152) sent to the quotation computing device (250) and are later transmitted to the 3D printing device (100) as part of the digital contract (150) created by the digital contract module (119) of the quotation computing device (250).

The bounding process module (116), when executed by the processor (101), defines a number of the processes used to print, form, or create the parts within the print job. These processes may include the activation of lasers, the deposition of building materials, the heating and/or cooling of parts during the printing process, post printing processes such as polishing or cutting, waiting a period of time for annealing of the parts, other processes used to form the parts, or combinations thereof. The processes defined by the process bound (151) may also be used to determine if the 3D printing device (100) can perform the processes defined in the digital contract (150) to ensure that the user's print job is executed as contractually mandated. The bounding process module (116) also defins process parameters that 3D printing device (100) is to use in printing the parts. Further, the bounding process module (116) assists, with the bounding proxy module (115), in creating the process bound (151) and part bound (152) for consumption by the quotation computing device (250) and later transmission to the 3D printing device (100) as part of the digital contract (150) created by the digital contract module (119) of the quotation computing device (250).

The build data (350) defines a manner in which the 3D printing device (100) is to build the parts to be printed based on the process bound (151) and part bound (152) created by the bounding process module (116) and the bounding proxy module (115). The part data (160) defines the actual parts that are to be printed and as created by the 3D model creation computing device (200) using, for example, a CAD program executed by the 3D model creation computing device (200). The CAD program executed by the 3D model creation computing device (200) creates a CAD model of the part that is in a file format appropriate for consumption by the 3D printing device (100) such as, for example, an object (OBJ), a stereolithography (STL) file, a virtual reality modeling language (VRML) file, a WRL file, an X3G file, a polygon (PLY) file, and other file formats. Thus, the 3D model creation computing device (200) sends the build data (350) and part data (160) to the 3D printing device for consumption of the build data (350) and part data (160) by the 3D printing device (100) in order to print the parts.

In one example, a number of the processes performed by executing the modules (115-120, 122) may be performed by the 3D model creation computing device (200). For example, a user may, at the 3D model creation computing device (200) request that a number of parts be printed by the 3D printing device (100). In this example, the user may execute the bounding proxy module (115), bounding process module (116), to trigger the execution of the quotation module (118), and digital contract module (119) of the quotation computing device (250) to begin entering into a signed and verifiable contract with the 3D printing device (100). By so doing, the user may define the process bounds (151), the part bounds (152), and time bounds (153) through execution of the bounding proxy module (115) and the bounding process module (116) by the processor (201) of the 3D model creation computing device (200). Through the execution of the success module (117) and the quotation module (118), a cost for printing the parts requested by the user may be displayed to the user of the 3D model creation computing device (200) on the display device (209).

The user may accept the terms of the contracted formed by accepting the terms defined by the process bounds (151), the part bounds (152), the time bounds (153), and the cost provided by the cost identifier (154). The digital contract module (119) may create a digital contract (150), which if accepted by a user, may be transmitted to the 3D printing device (100) for verification using the verification module (120) as to the digital contract's authenticity. An operator of the 3D printing device (100), a service provider, or a user may then instruct the 3D printing device (100) to print a batch of parts based on the part data (160) and digital contract (150) stored in the data storage device (202) of the computing device (200) by sending the part data (160) and digital contract (150) to the 3D printing device (100) and the 3D printing device (100) may execute the verification module (120) to verify the digital contract (150). Once the 3D printing device (100) verifies that the digital contract (i.e., a digital signature) is authentic and fits within the process bounds (151), part bounds (152), time bounds (153), the print module (121) of the 3D printing device (100), the printing device 100 may proceed with printing the parts.

In one example, the user may be given the option, before or after the execution of the verification module (120) of the 3D printing device (100), to cancel any request to print the parts covered by the digital contract (150). In some examples, the user may have second thoughts as to whether the parts should be printed at that time. Thus, in order to allow the user to have the option to cancel and change his or her mind, a prompt may be presented on either or both of the display device (109) of the 3D printing device (100) and the display device (209) of the 3D model creation computing device (200). The prompt may request a response from the user to proceed with the printing of the parts or cancel the print request. If the user accepts the printing of the parts and does not cancel the request, the 3D printing device (100) prints the parts. The instance of the digital contract (150) being used is persisted. In an example, a stored digital contract (150) usage count may be incremented by the increment module (122) on the 3D printing device (100), on the 3D model creation computing device (200), on a remote accounting device, or combinations thereof. In an example, a pre-paid digital contract (150) may be stored. In this example, the pre-paid digital contract (150) may be received from the remote accounting device, and usage of the pre-paid digital contract (150) may be decremented in the 3D printing device (100), the 3D model creation computing device (200), the remote accounting device, or combinations thereof.

In an example, the user who chooses to cancel the request to print the parts covered by the digital contract (150), any costs in time, electricity, wear and tear on the 3D printing device (100), and other costs may be passed onto the user as the requester of the print job. Further, in these examples where the user cancels the print job, the increment module (122) may or may not increment the usage count under the digital contract (150).

In an example, the user may provide the 3D printing device (100) with a plurality of digital contracts (150), and the 3D printing device (100) may automatically apply the best fitting digital contract (150) that fits a particular time frame or situation. For example, if the user has provided a first digital contract (150) that is valid in the months of January through March along with a more expensive digital contract that is valid between February and December, then a packed bed printed in March may automatically use the first digital contract (150) because while both digital contracts (150) are valid, the first digital contract (150) is cheaper.

Further, in an example, the user may provide the 3D printing device (100) with multiple builds, and the 3D printing device (100) may combine those into a smaller number of print jobs to reduce costs to the user. In this example, the 3D printing device (100) or another device may display on the display device (109), the total cost details and ask the user through a prompt on the 3D printing device (100) to confirm the total cost for the combined print job rather than the individual cost for each build prior to printing the parts.

With regard to the success module (117) of the 3D printing device (100) and/or the success module (117) of the 3D model creation computing device (200), in an example, the probability of success may be computed per part. In this example, the quoted price provided by the quotation module (116) may include a breakdown of the price of each part in the batch, where, if a part failed to print correctly, the cost for that part may be refunded to the user. Further, after a batch is printed, a success/failure ratio indicating an actual success rate of the printing of the parts may be sent from the 3D printing device (100) to the quotation module (118) of the quotation computing device (250) and/or the 3D model creation computing device (200) for use in adjusting the probability of success when generating subsequent digital contracts (150). Still further, in an example, after the parts have been evaluated during post-processing, the cost for any failed parts may be refunded, and that knowledge of failure may be sent to the quotation module (118) to facilitate refunds. The quotation module (118) may use this data in adjusting the probability of success when providing data to the digital contract module (119) in generating subsequent digital contracts (150).

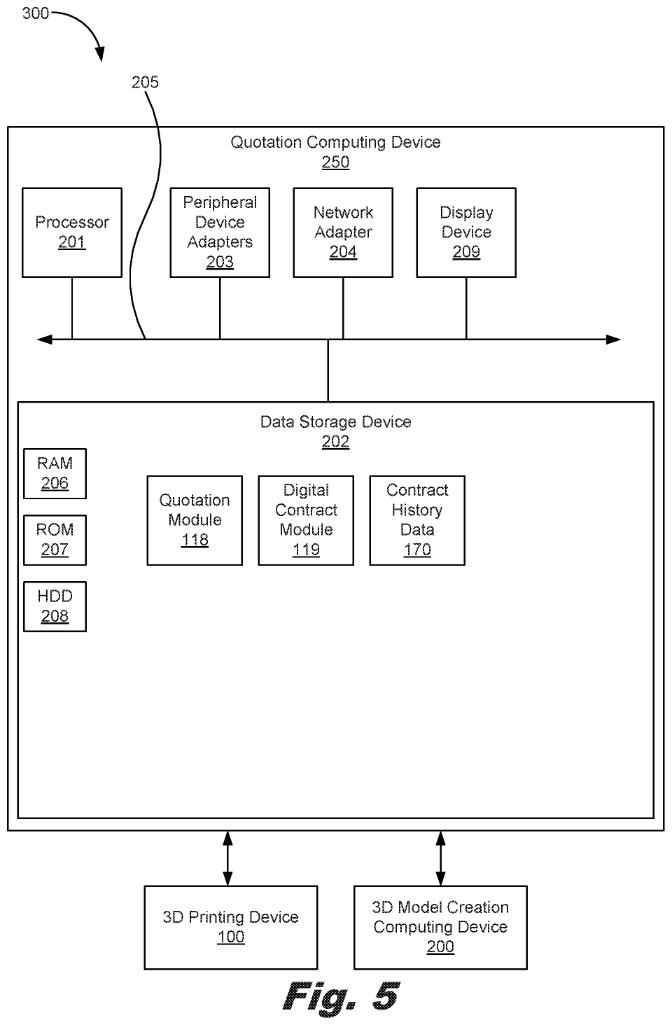

FIG. 5 is a block diagram of a quotation computing device (250), according to an example of the principles described herein. The quotation computing device (250) of FIGS. 2 and 3 is described in more detail in connection with FIG. 5. The quotation computing device (250) of FIG. 5 is communicatively coupled to the 3D printing device (100) and the 3D model creation computing device (200) of FIGS. 2 and 3, and includes its own processor (201), data storage device (202), peripheral device adapter (203), network adapter (204), RAM (206), ROM (207), HDD (208), and display device (209) coupled via a bus (205) that are similar to the processor (101), data storage device (102), peripheral device adapter (103), network adapter (104), RAM (106), ROM (107), HDD (108), display device (109), and bus (105) described above in connection with the 3D printing device (100) and the 3D model creation computing device (200) of FIGS. 2 and 3. In one example, the quotation computing device (250) may for part of the 3D printing device (100).

The quotation computing device (250) computes a cost for printing a number of parts or batches on the 3D printing device (100) based on the process bounds (151) and part bounds (152) received from the 3D model creation computing device (200), and creates the digital contract, (150) based on this information.

Further, the data storage device (202) of the quotation computing device (250) may store executable code in the form of modules such as the quotation module (118), and the digital contract module (119). Further, the data storage device (202) of the quotation computing device (250) may store contract history data (170). The contract history data (170) includes information regarding past digital contracts (150) the user and other users have previously entered into. In one example, the digital contract module (119) may use the contract history data (170) to prepare and/or offer a digital contract (150) to the user that may meet the user's desired contract. For example, a user may have previously obtained a digital contract (150) with a number of process bounds (151), part bounds (152), time bounds (153), and cost identifiers (154), and may wish to enter into the same or a similar contract. In this example, the contract history data (170) may be accessed by the digital contract module (119) to discover previous digital contracts (150) entered into by the user. This may expedite the user's experience with the methods and systems described herein that may result in a better user satisfaction.

As depicted in FIGS. 2 and 5, the quotation computing device (250) may send a digital contract (150) to the 3D printing device (100). The digital contract (150) to affirm that the print job for the parts is appropriate for the 3D printing device (100) and that the user is informed of the costs, efficiency, and security of the print job. As described herein in connection with FIG. 2, the digital contract (150) may be stored in the data storage device (102) of the 3D printing device (100) for analysis by the processor (101) of the 3D printing device (100), and may include a process bound (151), a part bound (152) for each part in a packed bed of parts, a time bound (153), and a cost identifier (154) to define a cost of printing the packed bed that is based on the process bound (151), the part bound (152) for each part in the packed bed of parts, and the time bound (153). In an example, the digital contract (150) may serve as or include a digital signature that authenticates the contract and, as a form of cryptographic protocol, indicates that the communications between a computing device used by the user and the 3D printing device (100) is authentic and secure.

The quotation module (118) computes costs associated with the printing of the parts and batches. In an example, the costs may be based on a process bounds (151), a part bounds (152), a time bounds (153), and a probability of success defined by the success module (117). The quotation module (118) provides the calculated costs to a digital contract module (119) for the digital contract module (119) to create a signed digital contract including the details of the computed costs. The quotation module (118) may create a cost identifier (154) including include a fixed cost per batch printing, a cost per part within a batch, a cost per cubic measurement (e.g., cubic centimeters), bulk costs if the user should request an amount of parts to be printed above a certain threshold, cost per printing of each print job or batch of parts, costs for printing a number of batches of parts, other cost parameters, and combinations thereof.

The quotation computing device (250) may also include a digital contract module (119) to create a digital contract (150) for signature by the user. The digital contract module (119) may produce the digital contract (150) that includes the process bounds (151), the part bounds (152), the time bounds (153), and the cost identifiers (154) described herein. Further, a form of cryptographic protocol may be applied to the digital contract (150) by the digital contract module (119) to create and maintain a level of security for the information contained within the digital contract (150) and described herein.

The 3D printing device (100) sends success data (270) to the quotation computing device (250). The success module (117), when executed by the processor (101) of the 3D printing device (100), determines a probability of success of printing the parts on a per part basis or a per batch basis. Data defining the probability of success and actual success rates of completed printing of the parts may be included as part of the success data (270). The quotation module (118) may use the success data (270) in determining the process bound (151), part bound (152), time bound (153), and cost identifier (154) for the digital contract (150) prepared by the quotation computing device (250) and sent to the 3D printing device (100).

In one example, the processes and functions of the quotation computing device (250) may be provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof.

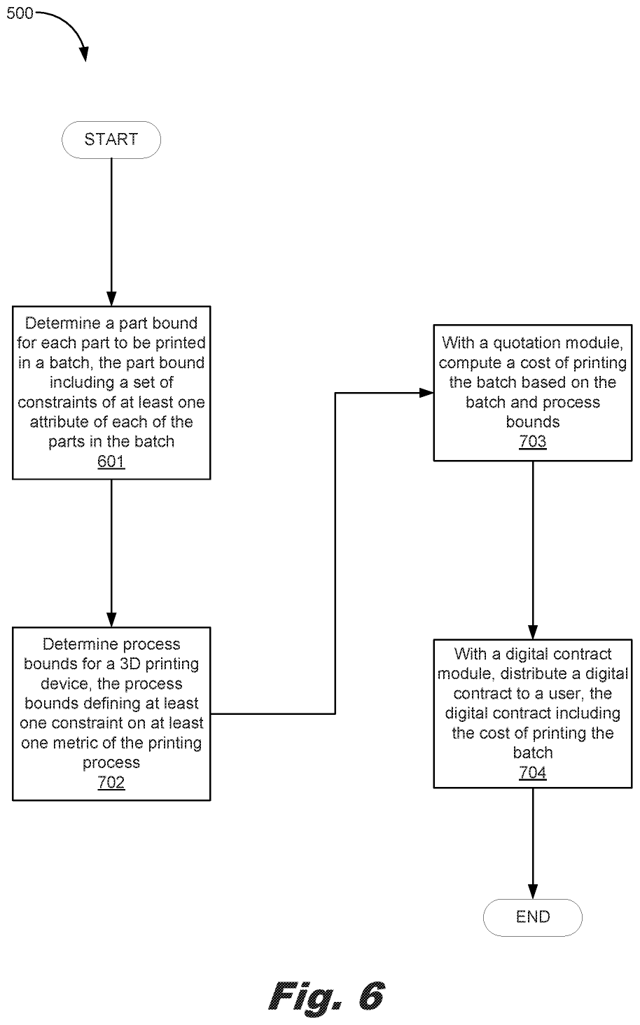

FIG. 6 is a flowchart showing a method (600) of 3D printing, according to an example of the principles described herein. The method of FIG. 6 may include, with the bounding proxy module (115) executed by the processor (101, 201), determining (block 601) a part bound (152) for each part (401) to be printed in a batch (400). The part bound (152) includes a set of constraints of at least one attribute of each of the parts (401) in the batch (400). The constraints may include a bounding proxy (402) including the size, shape, orientation, arrangement, and other attributes of the part (401). The part bound (152) for each part (401) defines a shape that individually encloses each of the parts (401) within the batch. The digital contract (150) maintains secrecy of the parts (150) within the batch based on a bounding proxy (402) of the part bound (152).

The method may also include determining (block 602), with the bounding process module (116) executed by the processor (101, 201), process bounds (151) for the 3D printing device (100). The process bounds (151) define at least one constraint on at least one metric of the printing process, and define the processes used to print, form, or create the parts within a print job. These processes may include the activation of lasers, the deposition of building materials, the heating and/or cooling of parts during the printing process, post printing processes such as polishing or cutting, waiting a period of time for annealing of the parts, other processes used to form the parts, or combinations thereof.

The method may also include, with the quotation module (118), computing (block 603) a cost of printing the batch based on the batch and the process bounds (151). Computing the cost of printing the batch may be based on the probability of success of the batch. Further, with the digital contract module (119), the method (600) may include distributing (block 604) a digital contract (150) to a user. The digital contract (150) includes the cost of printing the batch.

The method of FIG. 5 may also include, with the success module (117), determining a probability of success of the batch. Further, the method of FIG. 6 may include determining if the printing of at least one part (401) failed, and, in response to a determination that the printing of the part (401) failed, refunding costs associated with the printing of the part (401). Still further, the method may include sending failure information defining the failed printing of the part (401) to the quotation module (118), and adjusting a probability of success of the batch.

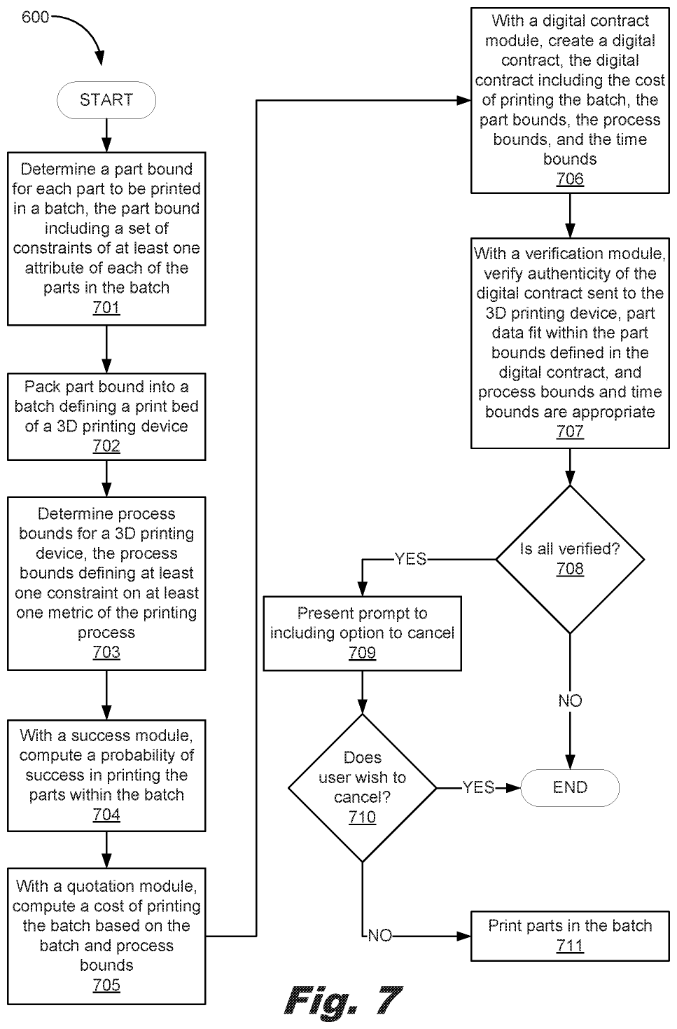

FIG. 7 is a flowchart showing a method (700) of 3D printing, according to an example of the principles described herein. The method of FIG. 7 may include determining (block 701), with the bounding proxy module (115) executed by the processor (101, 201), a part bound (152) for each part (401) to be printed in a batch (400), and packing (block 702) the part bound (152) into a batch (400) defining the print bed (FIG. 2, 201) of the 3D printing device (100). The part bounds (152) include bounding proxies (402), and bounds on the volume, density, surface area, applied colors, other parameters, or combinations thereof of the parts (401).

The method of FIG. 7 may also include, with the bounding process module (116) executed by the processor (101, 201), process bounds (151) for the 3D printing device (100). With the success module (117), the probability of success in printing the parts (401) within the batch (400) may be computed (block 704). In computing the probability of success, the success module (117) may do so based on an analysis of the parts (401), the packing of the parts (401) in the batch (400), and/or from comparing the packed batch (400) with previously-printed print beds (201) from the same or other users on the same or other 3D printing device (100).

The quotation module (118) may then be used to compute (block 705) a cost of printing the batch based on the process bounds (151), the part bounds (152), the time bounds (153), the probability of success as determined by the success module (117), and combinations thereof. A digital contract module (119) may be executed to create (block 706) the digital contract (150). The digital contract (150) may include the cost identifier (154) that identifies the cost of printing the batch (400), the part bounds (152), the process bounds (151), and the time bounds (153).

With the verification module (120), the authenticity of the digital contract (150) sent to the 3D printing device (100) may be verified (block 707). Further, at block 707, the verification module (120) may verify the part data (160) fit within the part bounds (152) defined in the digital contract (150), and whether the process bounds (151) and time bounds (153) are appropriate with regard to the batch (400). A determination may be made as to whether these items are all verified (block 708). If at least one is not verified (block 708, determination NO), then the process may terminate without the parts within the batch being printed by the 3D printing device (100).

In contrast, if the items are all verified (block 708, determination YES), then a prompt may be displayed on either or both of the display device (109) of the 3D printing device (100) and the display device (209) of the 3D model creation computing device (200) to the user that informs the user that the verification was in the affirmative and that the verifiable information is correct. The prompt also informs the user of the costs associated with the printing of the parts (401), and provides the user an option to cancel the printing of the parts (401) as block 710 provides for such a determination. If the user selects to cancel the printing (block 710, determination YES), then the process terminates without printing the parts (401) in accordance with the digital contract (150). If, however, the user wishes to continue with the printing of the parts (401) (block 710, determination NO), then the 3D printing device (100) prints (block 711) the parts (401) in the batch (400) in accordance with the digital contract (150).

In another example, the digital contract (150) may further include an estimated probability of successfully printing the batch using the process settings, and that probability may be displayed to the user along with the cost (154), allowing the user to make an informed choice with consideration not only for the cost, but also for the probability that the batch may fail.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (101) of the 3D printing device (100) and/or the processor (201) of the 3D model creation computing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a three-dimensional (3D) printing device. The 3D printing device includes a processor and memory communicatively coupled to the processor. The processor verifies that a digital contract certified by an authorized party is authentic and applicable. The digital contract includes a process bound, a part bound for each part in a packed bed of parts, a time bound, and a cost identifier to define a cost of printing the packed bed that is based on the process bound, the part bound for each part in the packed bed of parts, and the time bound.

The systems and methods described herein allow users to retain their part designs and proprietary print process settings secret by providing very tight bounds to gain the lowest price, or very loose bounds in order to keep the exact part shapes and process settings secret. If very loose bounds are used they can even obfuscate the process of packing a batch of parts within a print bed by allowing bounding proxies supplied for the pricing of the build to intersect. Further, users are free to make small changes to their designs and process settings, and so long as the changes remain within the bounds of the digital contract, the 3D printing device will be able to validate the digital contract and print the parts even without any network connection.

In one example, the quotation module described herein does not know the part or process details, and, of this reason, may be physically located elsewhere and secured to keep the pricing structure proprietary and secret. Further, the systems and methods described herein encourage printing of parts in batches with resulting gains in efficiency and lower costs. The 3D printing device displays an exact cost of the parts and/or batches before printing so there is no uncertainty for users, and the printing process is transparent while at the same time retaining privacy by way of preserving the secrecy of the parts, packing, processes and pricing structures.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for three-dimensional (3D) printing, comprising:
a bounding proxy module to determine a bounding proxy for each object to be printed in a batch within the 3D printing device, the bounding proxy comprising a set of constraints of at least one attribute of each of the objects in the batch;
a bounding process module to determine bounding properties for a print process of a 3D printing device, the bounding properties defining constraints on at least one metric of the printing process;
a success module to determine a probability of success of printing the batch; and
a quotation module to compute a cost of printing the batch based on the bounding properties and the probability of success of printing the batch.

2. The system of claim 1, comprising a digital contract module to distribute a digital contract to a user, the digital contract comprising at least the cost of printing the batch.

3. The system of claim 1, wherein the bounding proxy for each object defines a shape that individually encloses each of the objects within the batch, and wherein the digital contract maintains secrecy of the objects within the batch based on the bounding proxy.

4. A three-dimensional (3D) printing device, comprising:
a processor;
memory communicatively coupled to the processor, the processor to:
verify that a digital contract certified by an authorized party is authentic and applicable, the digital contract comprising:
a process bound;
a part bound for each part in a packed bed of parts;
a time bound; and
a cost identifier to define a cost of printing the packed bed that is based on the process bound, the part bound for each part in the packed bed of parts, and the time bound.

5. The 3D printing device of claim 4, wherein the digital contract defines a number of additional constraints comprising a limited time period in which the batch may be printed, a printer model, a printer instance, a number of print parameters, a number of printing processes, or combinations thereof.

6. The 3D printing device of claim 5, wherein verifying that the digital contract is authentic and applicable is performed by executing a verification module, wherein the verification module:
verifies that a printing process is within the process bounds defined by the digital contract;
verifies that a time window in which the packed bed is to be printed by the printing device is within time bounds defined by the digital contract; and
prints the packed bed of parts in response to a determination that the digital contract is authentic and applicable.

7. The 3D printing device of claim 4, comprising an increment module to increment a counter indicating a number of times the digital contract has been used.

8. The 3D printing device of claim 4, wherein the digital contract comprises:
data defined by a success module that determines a probability of success of printing the batch,
wherein computing the cost of printing the batch is based on the probability of success of the batch.

9. The 3D printing device of claim 4, comprising:
a success module to:
determine if the printing of at least one object failed; and
in response to a determination that the printing of the object failed, sending failure information defining the failed printing of the object to a quotation module to adjust a probability of success of the batch, the quotation module to calculate the cost of printing objects from the batch.

10. A method of three-dimensional (3D) printing, comprising:
determining a part bound for each part to be printed in a batch, the part bound comprising a set of constraints of at least one attribute of each of the parts in the batch;
determining process bounds for a 3D printing device, the process bounds defining at least one constraint on at least one metric of the printing process;
with a quotation module, computing a cost of printing the batch based on the batch and process bounds; and
with a digital contract module, distributing a digital contract to a user, the digital contract comprising the cost of printing the batch.

11. The method of claim 10, comprising, with a success module, determining a probability of success of the batch.

12. The method of claim 11, wherein computing the cost of printing the batch is based on the probability of success of the batch.

13. The method of claim 10, wherein the part bound for each part defines a shape that individually encloses each of the parts within the batch, and wherein the digital contract maintains secrecy of the parts within the batch based on a bounding proxy of the part bound.

14. The method of claim 10, comprising:
determining if the printing of at least one part failed; and
in response to a determination that the printing of the part failed, refunding costs associated with the printing of the part.

15. The method of claim 14, comprising:
sending failure information defining the failed printing of the part to the quotation module; and
adjusting a probability of success of the batch.
